(19) United States
(12) Patent Application Publication
(10) Pub. No.: US 2002/0065815 A1
(43) Pub. Date: May 30, 2002

(54) Systems and methods for searching a database

(75) Inventor: David Layden, Indianapolis, IN (US)

Correspondence Address: FOLEY, HOAG & ELIOT, LLP, PATENT GROUP, ONE POST OFFICE SQUARE, BOSTON, MA, 02109, US

(73) Assignee: Xcelerix, Inc.

(21) Appl. No.: 09/967,099

(22) Filed: Sep. 28, 2001

Related U.S. Application Data
(60) Provisional application No. 60/237,889, filed on Oct. 4, 2000.

(51) Int. Cl. G06F 17/30

(52) U.S. Cl. 707/3; 707/10; 707/100

(57) ABSTRACT

Systems and methods that retrieve at least one data element from a database include a database and a plurality of predefined query procedures, each predefined query procedure referencing an inquiry path, entering a query having a query procedure and at least one parameter, locating the query procedure and the referenced inquiry path, and using the referenced inquiry path with the parameter to retrieve at least one data element from the database, that is the result of the query. Generally, the system will be used to retrieve data for entity-relation databases (ERDBs) using Structured Query Language (SQL) queries, but that is not required.

### REFERENCE TO RELATED US APPLICATIONS

This patent application claims priority to U.S. Provisional Patent Application Serial No. 60/237,889, filed on Oct. 4, 2000, the entire disclosure of which is herein incorporated by reference.

### BACKGROUND

1. Field

The methods and systems generally relate to the field of database searching and more particularly to the use Structured Query Language (SQL) to search entity-relation databases (ERDBs).

2. Related Art

Database systems generally comprise a collection of data stored in various files, records, and fields, together with certain dictionaries, indexes, and the like, to permit quick and easy storage and access of the information within the database. In most contemporary database systems, each type or class of data is stored in a separate table with an appropriate index such that the logical intersection of the data from two separate tables may be examined by asking an appropriate query of the database. The computer system then examines each table in turn, extracting the required information from each table, which extracted information is then assembled in a correlated fashion for presentation in response to that inquiry. As a general rule, the time for response to the query is directly related to the number of tables which have to be examined or searched for the information and the length of each table. If the tables are indexed or otherwise ordered in a sequence based on criteria of the data stored in the file, then the access time can be reduced significantly within each file. Nevertheless, the coordination of the data from several files will still depend on a need to examine each file to retrieve the necessary information.

The storage of information in such general database tables is also related to their size and structure. While it is readily apparent that data could quickly be added to any table in random order, in the absence of some indexing method, retrieval of that same data from that table would require an examination of the entire table. If, on the other hand, either the table itself is organized in some sequential manner or an index is provided which allows the sequential order of the table to be established, then the time to enter data into the appropriate location or generate the appropriate index necessarily increases the time necessary to enter information into the table. As a general rule, the data itself is rarely placed in an ordered arrangement while the use of indexing arrangements is widely used. Nevertheless, the index in each given table is generally separate from, and has no relationship to, any other table maintained by the database at the same time and thus the correlation of information from two tables requires an independent search of each of the indexes employed in each of the tables into which access is required in order to retrieve information from multiple tables.

Structured Query Language (SQL) is a language of specific commands which has been generated to search some of the types of these databases, which are commonly called relational databases. The language provides commands for the joining of data across multiple tables and for the return of certain data elements from the database. The language is in wide general use, but is reliant on the form of database. In particular, SQL is designed to search through multiple tables combining information from them, but must search through each individual table as described above. This means that structure in the data may be lost by the storage process and later recreated by the query. Each individual database table (dataset) is efficiently searched to provide the result, but they are searched separately, which does not allow inherent structure in the data to aid in the search.

The need to generate multiple indexes in order to deposit related information into multiple tables of a single database and, perhaps more importantly, the need to search multiple indexes in order to retrieve related information from multiple tables of a single database significantly slows the operation of a database. Although, in many circumstances, a delay may be tolerable, as data collection and retrieval becomes more important and the amount of data collected becomes vast, the speed with which data can be retrieved becomes of paramount importance.

U.S. Pat. No. 5,560,006 discusses one example of an entity-relation database (ERDB) which can be used as a faster method of retrieving information from a database than many conventional forms. Although the system is disclosed for use with many types of applications, previously it has not been possible to search an ERDB using SQL queries or other common query languages which has limited the application of ERDBs in many common applications.

It is therefore desirable in the art to have a method that allows queries programmed in SQL or other common query languages to perform searches on an ERDB, or to allow programmers to program queries in SQL or other common query languages while still acting on an ERDB.

### SUMMARY

The following discloses, among other things, systems and methods for retrieving at least one data element from a database including having a database and a plurality of predefined query procedures, each predefined query procedure referencing an inquiry path, entering a query having a query procedure and at least one parameter, locating the query procedure and the referenced inquiry path, and using the referenced inquiry path with the parameter to retrieve at least one data element from the database, the data element being a result of the query.

In one embodiment, a Structured Query Language (SQL) query may be used as the query, and another embodiment may use an entity-relation database (ERDB) as the database. The database may be searched by a linked list, potentially that loops.

Another embodiment may comprise the creation of a database designed to utilize the above searching.

Other features and advantages will become more apparent from the following detailed description, taken in conjunction with the accompanying drawings which illustrate, by way of example, the principles of the embodiments.

### BRIEF DESCRIPTION OF THE DRAWINGS

The following figures depict certain illustrative embodiments in which like reference numerals refer to like elements. These depicted embodiments are to be understood as illustrative and not as limiting in any way.

FIG. 1 shows the contents of a representative entity field including an address and sort index;

FIG. 2 shows a second entity field owned by the entity field of FIG. 1;

FIG. 3 shows a pointing field relating the entity field shown in FIG. 1 to yet another entity field;

FIG. 4 shows an entity linked list giving the inverse relation to that shown in FIG. 3;

FIG. 5 shows the combination of a linked list and pointing list to relate the entity field of FIG. 1 to yet another entity field forming an entity-relation database (ERDB);

FIG. 6 shows another combination of linked list and pointing list to define the inverse relation to that given in FIG. 5;

FIG. 7 shows the concatenation of the data in FIGS. 5 and 6 into another ERDB;

FIG. 8 shows a flowchart of one embodiment using an SQL query with an ERDB;

FIG. 9 shows a second flowchart of another embodiment using an SQL query with an ERDB;

FIG. 10 shows tables expressing the data from FIG. 5 in a manner consistent with a relational database;

FIG. 11 shows tables in a relational database with more complicated data and data interrelationship than FIG. 10; and

FIG. 12 shows the linked list format, or virtual table, of the data in FIG. 11.

### DESCRIPTION OF THE PREFERRED EMBODIMENTS

The embodiments herein are described primarily in terms of an entity-relation database (ERDB) such as that described in U.S. Pat. No. 5,560,006 the disclosure of which is herein incorporated by reference. The database used need not be this type of database, and other types of databases, including other types of ERDB, known to the art could be accessed by the methods and systems of these embodiments. The description of the embodiments further discusses the use of Structured Query Language (SQL), SQL queries, and embedded SQL (ESQL). The references below will generally refer to operations in “ANSI” or standard SQL however one of skill in the art would quickly be able to adapt the principles given below for use in other versions of SQL including all open-source, proprietary or other versions of SQL. Embodiments could rapidly and without undue experimentation also be adapted to other query languages and/or query forms instead of, or in addition to, SQL as would be readily understood by one of skill in the art. Further, the ERDB and relational databases shown in the figures are exemplary only and the data therein provided is meant to be only a single example of the universe of data which could be present. The data could be of other types and for other purposes, and the choice of data relating to automobiles should in no way limit the scope.

To begin, it is best to describe how an ERDB stores and retrieves data. The ERDB of one embodiment is constructed to contain two different types of data-receiving fields referred to generally as entity fields. The two different kinds of entity fields containing arrays of data elements are called “key fields” and “item fields”. Key fields are fields which contain an array of data entries each of which is unique. In a entity-relation database of the preferred embodiment, all key fields are sorted or indexed as the entries are made into the field. Thus, the entries of a key field form at all times an ordered array similar to a flat file which can quickly be searched using a binary search process, or any other search process as would be understood by one of skill in the art, to locate the desired entry without having to read all the entries in the field. An example of a key field is one containing a list of the serial numbers assigned to the articles of a particular manufacturing process. Since no two articles of the same process have the same serial number, it follows that the field containing the list of the serial numbers is one in which each entry is unique.

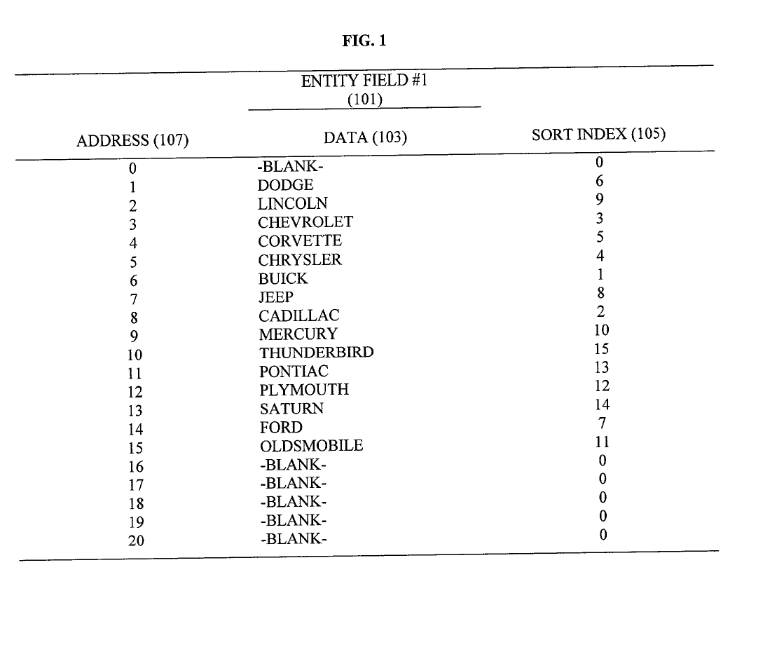

Another example of a key field is entity field #1 (101) as shown in FIG. 1 containing a list of data elements (103) which are the makes of automobiles. It is be to noted that while the data elements of the field are not ordered within the field, a sort index (105) is provided which orders the data elements of the field based on a characteristic of the data elements, namely, their alphabetic order. It is to be understood that any other characteristic of the data elements, such as word length, could be chosen if so desired. Only arrays of data elements which are capable of some sort of ordered arrangement can form key fields, but the data elements can be information of any type what-so-ever including a list of memory addresses (107).

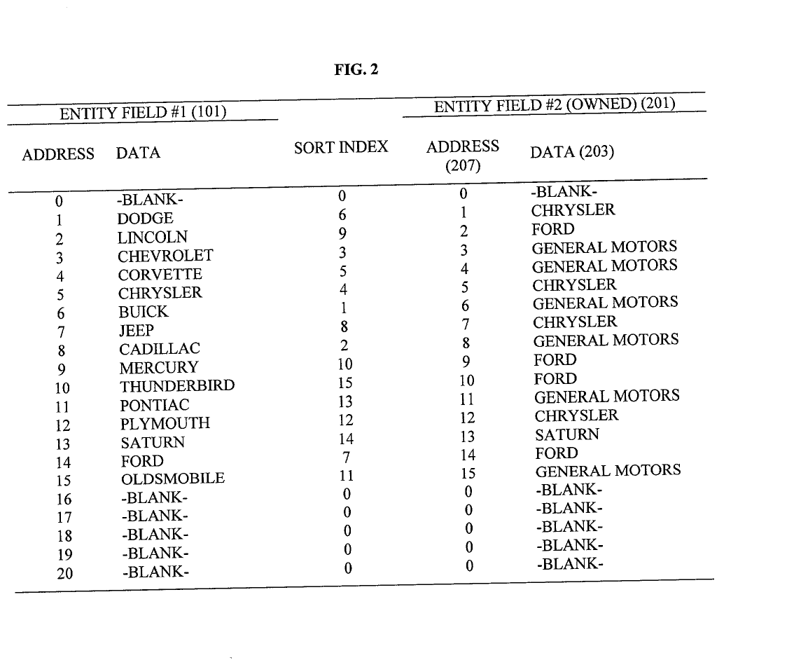

An item field, on the other hand, is one which contains entries which are not necessarily unique. Since item fields can contain entries which are duplicates of other entries in that same field, retrieval access to the information in an item field must be through another field, which other field is said to own the item field. An example of an item field is one containing a list of all the model numbers of parts produced in the order of their production where a multitude of parts carrying each model number is manufactured. Such an item field could be accessed, for example, by way of another field containing merely time/date entries reflecting the time and date of completion of the parts. FIG. 2 shows one example of an item field as entity field #2 (201). In FIG. 2 the corporate manufacturer of each of the makes of automobiles listed in entity field #1 (101) is provided. Entity field #2 (201) is owned by entity field #1 (101) and is accessed through that field. Again, an item field could be nothing more than an array of addresses of other data entries where the addresses given can contain duplicates. The array of addresses for Entity field #2 (201) is address list #2 (207) and the non-unique data items are the data in data field #2 (203).

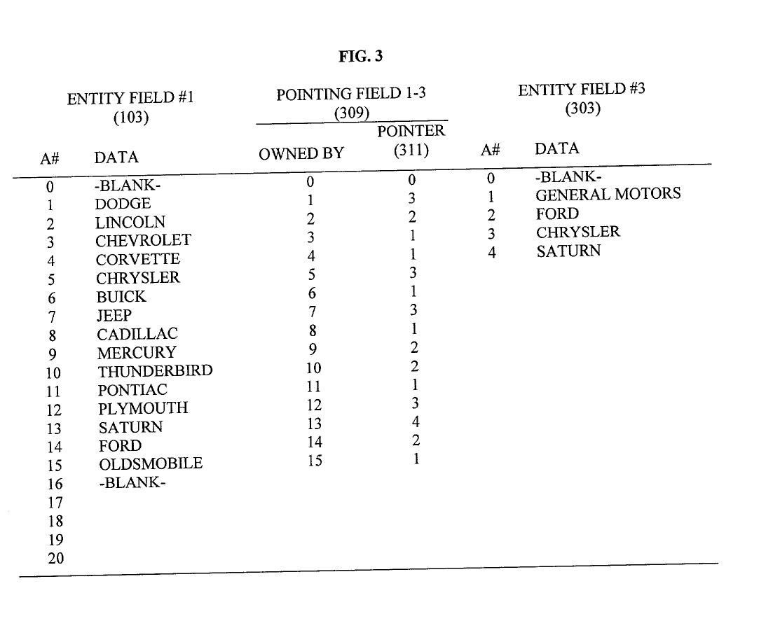

An entity field containing an array of addresses, whether structured as a key field or as a item field, has particular use in one embodiment of an ERDB, and is referred to as a pointing field. A pointing field is a relationship defining field. The function of “pointing” implies that a one-to-one or a one-to-many relationship exists between a pointing field and another field. A given pointing field will generally only point to a single other field, not to two or more. On the other hand, a given field can be pointed to by many other fields. FIG. 3 shows an exemplary pointing field 1-3 (309), which is owned by entity field #1 (101), pointing to the addresses of the various data elements of entity field #3 (303). The reader should note that entity field #3 (303) is similar to entity field #2 (203) but redundant entries have been eliminated in favor of the pointer (311). The incorporation of the pointing field allows, but does not require, entity fields to become key fields by removal of redundant entries.

In one embodiment of the ERDB, all entities are related to each other by relationships defined at the time of establishing the database. There are three fundamental kinds of relationships, namely, a one-to-one relationship, a one-to-zero or more relationship (which can also be thought of as a one-to-many relationship, where “many” can have any value including zero), and a many-to-many relationship. In addition to the direct relationships, chain relationships are also implied. That is, if entity field A has a one-to-one relationship with entity field B, and entity field B has a one-to-one relationship with entity field C, then it is implied that entity field A has a one-to-one relationship with entity field C. The entity fields are organized by relationship defining fields into a logical structure which allows query paths to be built into the structure. Once the relationships are defined, the data entered into the database is quickly and easily accessed.

In order to define a many-to-many relationship, it is desirable in one embodiment to use a linked list relationship between two independent keys and limit allowed queries to go from either one direction or the other. To use an example, if both A and B are independent keys that share a many-to-many relationship, a one-to-many relationship can be formed from A to B, a one-to-many relationship can also be formed from B to A. Queries can be created which use the one-to-many relationship in one direction. This setup allows for a many-to-many relationship to be simplified, but limits the available queries.

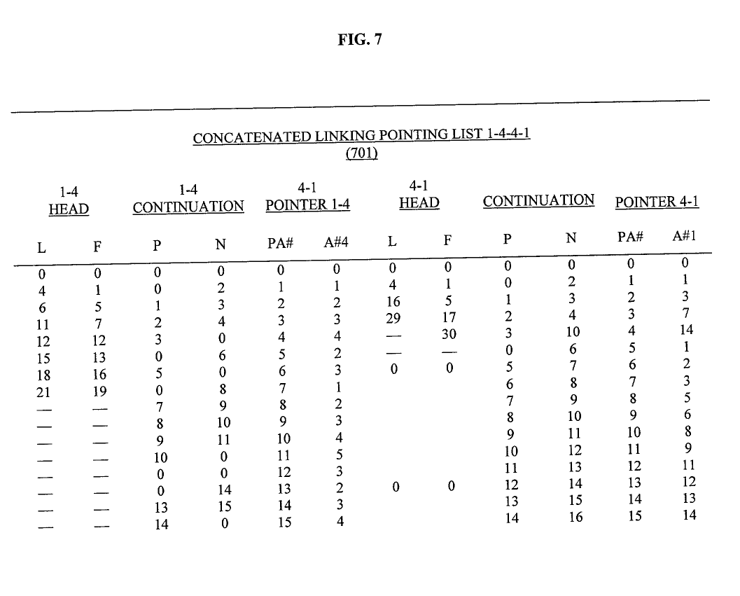

In another embodiment, many-to-many relationships can be handled through the use of a concatenated key, which includes all the members of the many-to-many relationship. To use the similar example as above, the concatenated key would be AB containing all the combinations of A and B. A would then have a one-to-many relationship with AB (as would B) each member of AB would then have a one-to one-relationship with B (or A). This embodiment of a many-to-many relationship is shown in FIG. 7, as will be described later.

To accomplish the ready data retrievability desired in an ERDB system, it is desirable to also use an additional relationship defining field to construct the desired data query paths. The additional relationship defining fields are in the form of linked lists that establish a one-to-many relationship between two fields, which may be entity fields or other relationship defining fields. The linked lists thus constitute indirect addressing for each entry in two other fields, which may be entity fields or other relationship defining fields. Linked lists may be internally organized as “doubly-linked lists”, with the values being inserted in each of the doubly-linked lists in such a fashion that retrieval of the relationship information may be obtained in either direction. This layout is used in the following examples.

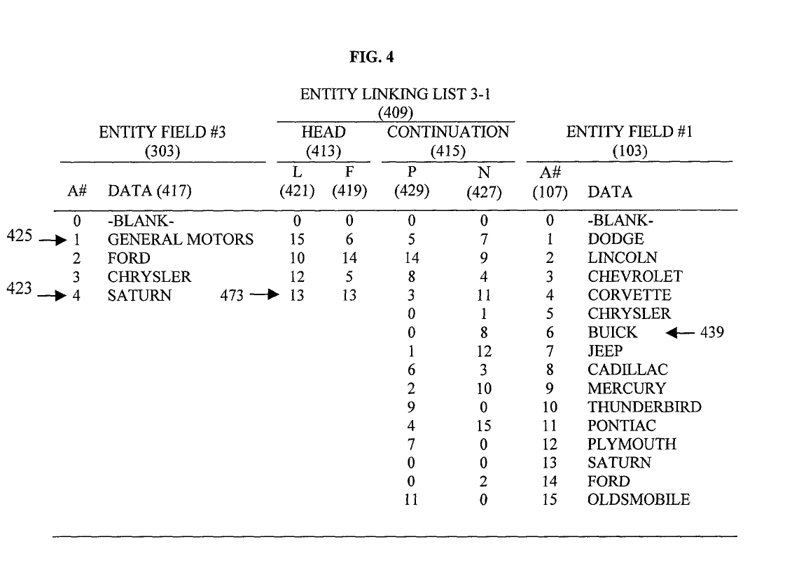

As shown in FIG. 4, a linked list, such as entity linked list 3-1 (409), may be composed of a head portion (413) and a continuation portion (415). The head portion (413) is owned by a first field and points to a second field, while the continuation portion (415) is owned by the second field and points to other elements in the second field. In FIG. 4 the manufacturers listed in entity field #3 (303) are linked to the various makes of automobiles they manufacture listed in entity field #1 (103) by entity linked list 3-1 (409). The head portion (413) of entity linked list 3-1 (409) is seen to comprise a pair of numbers (419) and (421) for each data entry (417) in entity field #3 (303). The numbers listed in column F (419) point to the address (in the address list (107)) of the first member of entity field #1 (103) which is related to the given entry in entity field #3 (303). The numbers given under column L (421) give the address (in the address list (107)) of the last data element in entity field #1 (103) related to the given data element in entity field #3 (303). Where there exists only a single member in entity field #1 (103) which is related to the element in entity field #3 (303), the numbers appearing in both column L (421) and column F (419) are the same, for example, as shown under the entry for the item (473) at address 4 (423) of entity field #3 (303). Where there is more than one data entry in entity field #1 (103) related to the data element in entity field #3 (303), the numbers appearing in columns L (421) and F (419) are different from each other and represent the first and last member of the group of related data elements existing in entity field #1 (103). The item (425) at address 1 shows an example of this. In order to find the remaining elements, it is necessary to go to the continuation portion (415) of the entity linked list.

The continuation portion (415) of the linked list can be considered to be owned by the entity field #1 (103) and gives the address within entity field #1 (103) of the next and previous elements which are related to the same element of entity field #3 (303). The column N (427) and the column P (429) provide the next and previous address respectively. For example, entity field #3 (303) lists General Motors as a manufacturer as the item at address 1 (425) and specifies that the first member of the related data elements in entity field #1 (103) is found at address 6 (the value of column F (419) corresponding to the same row as general motors, that is the row at address 1 (425)). The element at address 6 (439) (in address list (107) of entity field #1 (103)), includes the data “Buick”. Also included with the element at address 6 (439), is the indication that the next related data element is to be found at address 8 (the value in Column N (427) corresponding to that address). This process can then be continued looking at the corresponding data and continuation portions for each of the new elements retrieved. Thus, in this example, at address 8, appears the data entry “Cadillac” and in the continuation list, the next entry is listed as 3. Under address 3, the data entry is “Chevrolet” and the next entry given in the continuation list is address 4. At address 4, we find the data entry “Corvette” and in the related continuation list, the identification of the next entry to be at address 11. At address 11, we find the data entry “Pontiac” and in the related entry in the continuation list, we find the next address 15. At address 15, we find the entry “Oldsmobile” and in the continuation list, we find the entry “0”. This zero entry symbolizes the end of the list. Thus the list of all makes of automobiles manufactured by General Motors has been generated by following the addresses listed in the F column (419) of the head portion (413) and the N column (427) of the continuation portion (415) of Entity Linking List 3-1 (409).

This same list can be generated in reverse order by looking at the entries under column L (421) and column P (429) in the head portion (413) and continuation portion (415) of Entity Linking List 3-1 (409), respectively, where L stands for the last item of the list and P stands for the previous item in the list. That is, the last item given under General Motors (the data at address 1) (425) in the head of the linked list is address 15 which in entity field #1 (103) reveals the data entry “Oldsmobile” and in the related continuation list gives the address 11. At address 11 is the data entry “Pontiac” and the related continuation address under the P column of 4 and so forth. Thus, the linked list may be viewed as two loops extending from a single entry in entity field #3 (303) over to all of the related entries in entity field #1 (103) which strings together, like beads on a string, related data elements in the two entity fields. Furthermore, the order of elements is seen to be given by following the numbers which, for General Motors, is 6, 8, 3, 4, 11 and 15. Following the same series using the last and previous numbers one achieves the series 15, 11, 4, 3, 8 and 6. It will be quickly realized that these two number series are opposite from each other and can be employed to check the integrity of the linked list. Furthermore, if one sums together all of the addresses given in the last and previous columns and all of the addresses given in the first and next columns, both sums should be the same since each address, with the exception of the zero address, appears only once. It is to be noted that the linked list can be constructed such that the order of entries retrieved from entity field #1 (103) is in a predetermined order. In the example shown, the order is alphabetic but could be any other order specified.

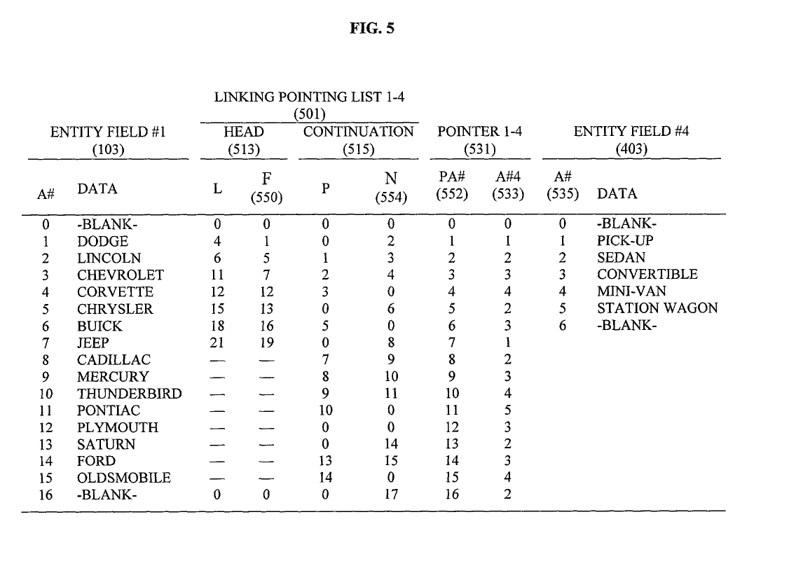

While the illustrated linked list directly relating entity field #3 (303) to entity field #1 (103) may be satisfactory where there is a one-to-one relationship between the members of the field, such a linked list may not be satisfactory where there is a one-to-many relationship. In that circumstance, it may be desirable to employ a linked list together with a pointing list to relate the two entity fields. An example of such a linked pointing list is found in FIG. 5 where the entity field #1 (103) gives the makes of the various automobiles and is related to entity field #4 (403) which gives the models of various types of automobiles. The linking pointing list 1-4 (501) establishes the relationship between types of vehicles for each make given in entity field #1 (103). The linked list itself has a head portion (513) which is owned by the various data elements of entity field #1 (103). The continuation portion (515) does not relate to the addresses of entity field #4 (403), but rather to the pointer addresses (533) of pointer field 1-4 (531) which in turn points to the address numbers (535) of entity field #4 (403).

Thus, it will be seen that address #1 in entity field #1 (103) contains the make “Dodge” and the corresponding member in column F (550) of head portion (513) points to the first member of pointer field PA# (552). The corresponding pointer address (533) points to address 1 of entity field #4 (403) for “pick-up”. In the column N (554) of continuation field (515) corresponding to the first member of PA# (552), it lists the next address of PA# (552) as address 2 for which the corresponding pointer address (533) in turn points to address 2 in entity field #4 (403), etc. By tracing the continuation portion of the linked list together with the pointer, one discovers that Dodge manufactures a pick-up, a sedan, a convertible and a mini-van, but not a station wagon. Lincoln manufactures only a sedan and a convertible. Chevrolet manufactures all five models listed in entity field #4 (403). Corvette manufactures only a convertible. It will be quickly appreciated that while entity field #1 (103) has only 15 entries and entity field #4 (403) has only five entries, the pointer field 1-4 (531) referred to by the continuation of the linked list may have 50 or 60 entries. This is illustrative of the fact that an ERDB can have many more relation defining entries than information data entries thereby forming a so-called “sparse matrix” or fourth normal form data storage system.

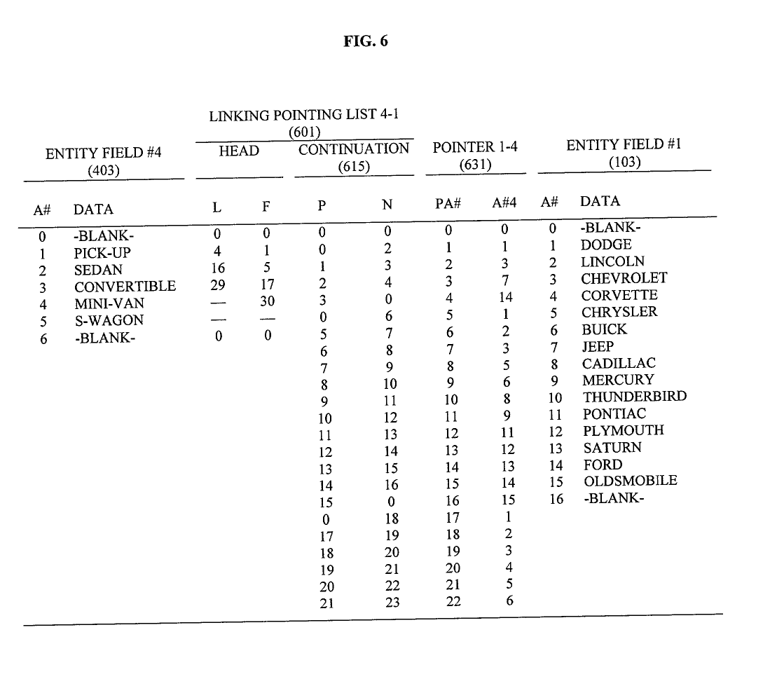

While FIG. 5 gives the linking pointing list 1-4 (501) from which one could extract all of the types made for each make of automobile, FIG. 5 does not generate the reverse information, namely, all of the makes of automobiles for any given type. This relationship is specified by FIG. 6 which is again a linked pointing list. From linking pointing list 4-1 (601), one can discover that pick-ups are manufactured by Dodge, Chevrolet, Jeep, and Ford, while sedans are manufactured by every member of entity field #1 except Corvette, Jeep and Thunderbird. Again, the number of entries to be found in the continuation portion (615) of the linked list and the related pointer list 4-1 (631) far exceeds the number of entries in either entity field #4 (403) or entity field #1 (103).

The two linking pointing lists 1-4 (501) and 4-1 (601) shown in FIGS. 5 and 6 taken together define the total union of the many-to-many relationship between two sets of data found in entity field #1 (103) and entity field #4 (403). FIG. 7 shows such a concatenation of the linking pointing lists 1-4 (501) and 4-1(601) as concatenated linking pointing list 1-4-4-1 (701). Such a concatenation is not restricted to merely the concatenation of the two entity fields. Any number of entity fields can be so related together, the fields being interrelated across each other or at varying levels of depth. To put it another way, there may be five fields which each relate to a single key field or they may interrelate so that field 1 links to field 2, field 2 links to field 3, etc. Further, each array of addresses of other data entries can itself be considered as a field which may be accessed through linked lists and pointer lists as necessary in order to define all of the needed relationships of a given database.

Often the linking relationships are more complicated than one might first imagine. This may require one to carefully consider and plan the inquiry paths that will be used to access the ERDB and may encourage one to continuously modify the inquiry paths based on an examination of the data reflecting the actual workings of the ERDB. The addition of inquiry paths through the use of new linked pointing lists can be done at any time. These inquiry paths can be related to structured query language (SQL) queries or to other language queries where the language is not principally used for accessing an ERDB. This relationship allows a specific SQL query to call a particular inquiry path enabling retrieval of the desired information.

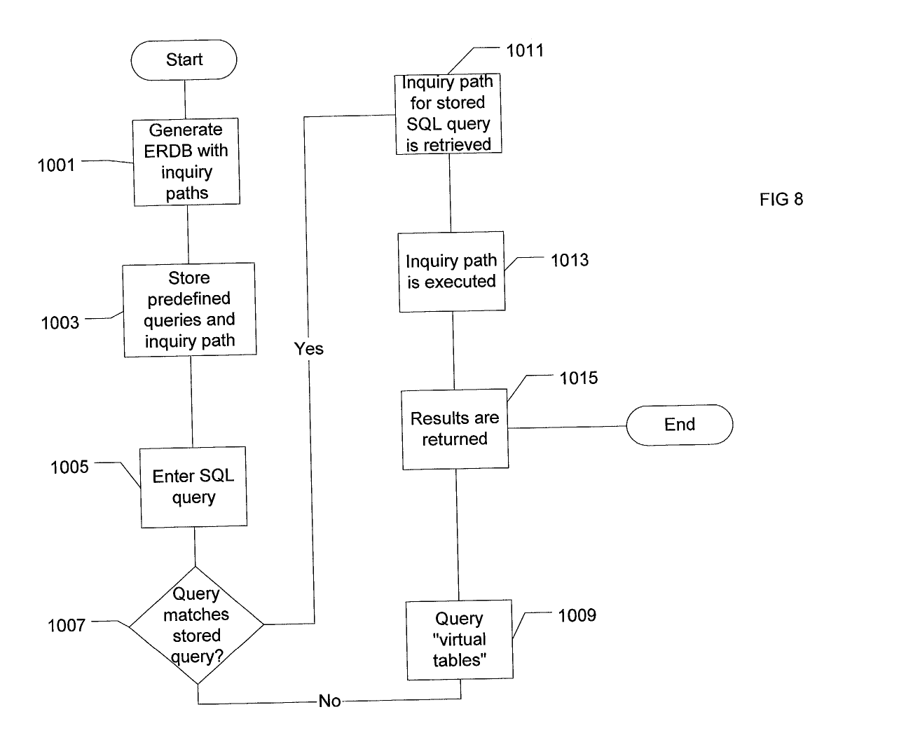

FIG. 8 shows a flowchart of the basic operation of one embodiment where data is retrieved from an ERDB by entering a SQL query. SQL is used in the figures and examples since it is one of the most common query languages. However, one of skill in the art would see that the principles, methods, and systems contained herein could be used for any language. The use of SQL in this disclosure should be taken to include all of these additional languages.

In the step (1001) the ERDB is generated, with the relationships defined to take into account likely SQL query's. The ERDB is set up so that the inquiry paths can correspond to likely SQL queries. In particular, the SQL queries are recognized to have similar procedures. That is, they will perform similar types of searches, for different particular data elements.

As was discussed above, the searches performed using SQL will generally be of a form that creates a union of multiple tables of data. Therefore the ERDB can be generated so as to take the expected union into account, because the ERDB includes information related to the interrelationship of pieces of data. In step (1003) the collection of predefined SQL query procedures is stored along with the ERDB inquiry path that will return the value of that SQL query. This method of storage can comprise methods known to the art, and will generally consist of the storage of the query as a procedure and a parameter. The procedure will generally comprise the search instruction, i.e., the statement of where to search and what to return. The parameter will comprise an open variable which will take on the value of that variable defined by the user in a specific query.

To provide a generalized example, “Return all movies with ? as the title” comprises the search procedure. No matter what the title is, the search will generally be performed in a similar manner. The “?” is the parameter that has no value for the general search. The titles “Gone with the Wind” or “Star Wars” are user defined variables that will be assigned to the parameter in a particular search.

In step (1005), a user enters an SQL query to perform some sort of search. In step (1007), this query is then analyzed to see if it has a procedure that is similar to one of the stored procedures. If it does not, a standard SQL search can be performed on “virtual tables” generated by the ERDB (1009). If the query is similar to one of the known queries, the inquiry path for retrieving the desired data from the ERDB is retrieved and performed, passing through the value of the parameter for that specific search (1011). Thus the question “return all movies with Gone with the Wind in the title” may become locate the title “Gone with the Wind” in entity field “title” and return the associated linked list. The inquiry path is then executed in step (1013) to return the linked list of results in step (1015) which corresponds to the query and parameter entered by the user.

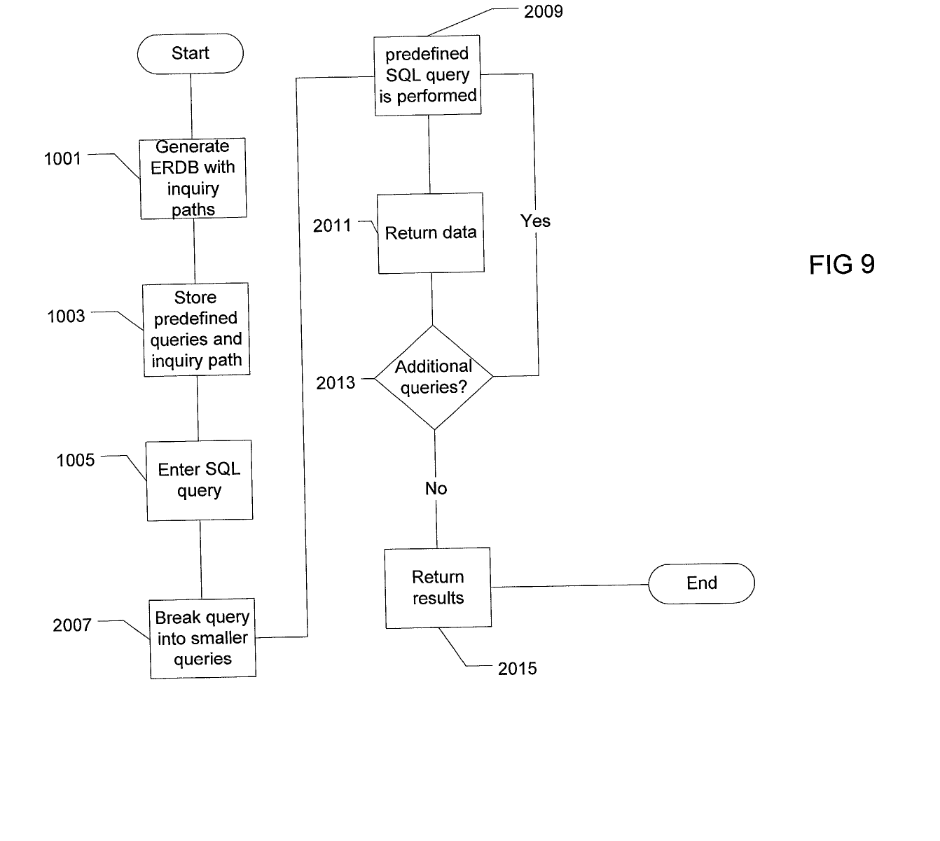

In an alternative method, shown in FIG. 9, the first steps are identical, but in step (2007) the user's provided SQL query is broken down into a collection of predefined queries. In step (2009), the first of these queries are performed and a linked list of data is returned in step (2011). Step (2013) now determines if there are additional queries to perform and performs them, otherwise the system returns the results at step (2015). FIG. 9 will often be the type of organization used in embedded SQL.

To further explain the method, it is best to first examine the structure of a SQL query and how SQL is designed to interface with a database. A SQL query is designed to search through a relational database which is arranged in tables. The ERDB can be searched by a SQL query because the ERDB can be thought of as providing “virtual tables” that can interact with the SQL language.

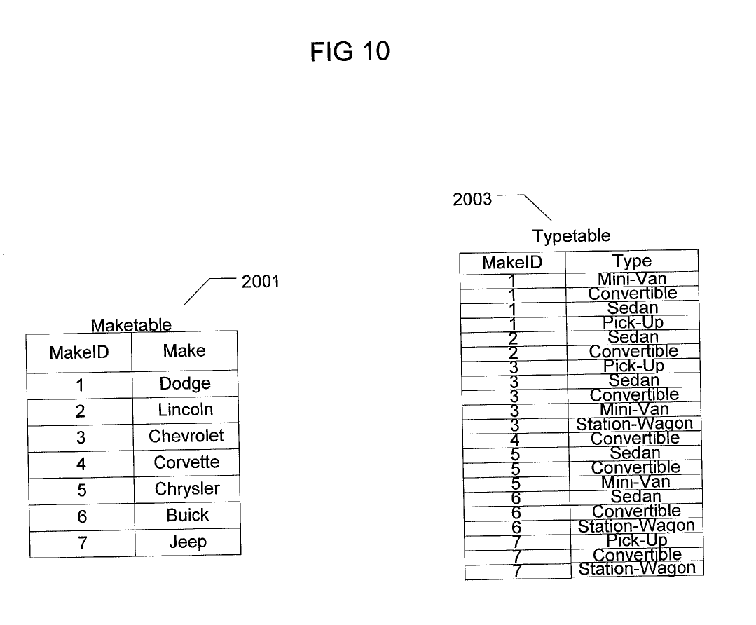

FIG. 10 shows a relational database view of a subset of the data in the ERDB of FIG. 5. A few items should be immediately apparent. The first of these is that there is significant redundant information in the typetable (2003). For instance, the first table, maketable, (2001) contains the same number of entries as entity field #1 (103) of FIG. 5 for the chosen subset, while the second table, typetable, (2003) contains multiple redundancies of the information in entity field #4 (403) of FIG. 5. This is similar to what had existed in FIG. 2.

It should also be apparent that these tables could be readily generated by using the linked list of FIG. 5. One would simply have entity field #1 (103) of FIG. 5 be the maketable (2001) and then use the linking pointing list 1-4 (501) of FIG. 5 to generate the typetable (2003) for each makeID of maketable (2001) as was previously described in relation to FIG. 5.

SQL searches these tables by taking in the information of the query and comparing the information in the query to the information in a table. A user tells SQL which columns of which tables to look at and what you are looking for, and then SQL finds all the corresponding matches. The most common form of SQL command is the SELECT command which is used to return specific information from certain columns. One might, for instance, SELECT maketable.make which would return all the values of the make column of the maketable. To return the intersection of two columns one would simply need to select each column specifically and state the intersection. For instance, the following select command:

| | |
|---|---|
| SELECT maketable.make, typetable.type | [1] |
| FROM maketable, typetable | |
| WHERE maketable.makeID = typetable.makeID | |

will return a list of all the types of cars made by all the manufacturers.

The limitation of this searching strategy is in its methodology. The SQL statement must compare every value of maketable.makeID in turn and match it up with the value of typetable.makeID. The search strategy for finding the matches can be of any type but for the purposes of explanation, this discussion will assume the table is searched according to a perfect binary tree. Each search, therefore, requires searching log2 of the total number of entries (the number of entries in typetable (2003)). Binary tree searching is well known in the art and described in Sedgwick, Robert; Algorithms (Addison-Wesley, 1983) (ISBN 0 201 06672-6), the disclosure of which is herein incorporated by reference. Since there are 7 entries in the maketable (2001) and 21 entries in typetable (2003) this means the total number of searches required is 7*Log2 (21), or about 30 searches.

The SQL searching of this example, further requires that there be an order imposed on the values so as to enable binary searching. This means that every table must have an index to enable searching or else the search will break down and speed will be lost. To search for a particular group of entries, for instance, if the user wanted to know all the types of cars made by Chevrolet they could enter the following search:

| | |
|---|---|
| SELECT maketable.make, typetable.type | [2] |
| FROM maketable, typetable | |
| WHERE maketable.makeID = typetable.makeID and | |
| maketable.make = Chevrolet | |

This search would comprise a first search of the maketable (2001) for maketable.make values that are equal to Chevrolet (which is Log2 (7) searches). This MakeID will then be compared to every value of MakeID in typetable (2003) to get the type. This corresponds to Log2 (7)+Log2 (21) or about 8 searches. This searching scheme further has to assume that typetable has a non-pictured index on the column MakeID which enables the binary searching.

A still further problem with this SQL searching, is not in the searching speed, but occurs in the speed that the data can be returned from the database to the user. Since there is repetitive information in the tables, when the values of the SQL query in a traditional database are returned, that repetitive information is also returned. To show an example, using query [2] above, the database will perform the above search and will return the value of the maketable (2001) (which will always be Chevrolet), along with the value of the typetable (2003) for every corresponding data point. This means that the database must return duplicate information. In particular, it will return Chevrolet sedan, Chevrolet pickup, Chevrolet convertible, etc.

This is problematic in systems where the speed of downloading is particularly important. The data element “Chevrolet” has a particular size, and that size is now being sent multiple times, without additional information being imparted. Thus, the transmission of the data from the database requires more transmission bandwidth, and storage space, than it would without redundant information. This increased bandwidth is particularly problematic on databases that are accessed via a network such as, but not limited to, the World Wide Web or Internet.

On networks, a server, which contains or references the database, is often accessed by many separate clients simultaneously. Multiple SQL queries may be received by the server in rapid succession or even simultaneously. Further, each of these clients can represent an individual user trying to get information. On the World Wide Web, this often may be information related to potential sales. Some of the largest e-commerce Websites use databases to provide information back to potential customers. Databases can provide a list of books, CDs, cars, videos, or any other products that the site has available for sale. The SQL search enables the user to return those values of interest to them.

The user has limited patience, however, and may have limited bandwidth with which to receive information related to their search. In addition, the more queries that an individual server can handle, the fewer servers that are needed by the e-business and the more cost effective the e-business can be. It is therefore desirable to have the information in the database be retrieved as quickly as possible (to save server time) and to make transmission of that information take as little bandwidth as possible (to enable quicker transmission to clients and also to save server time in the transmission process.)

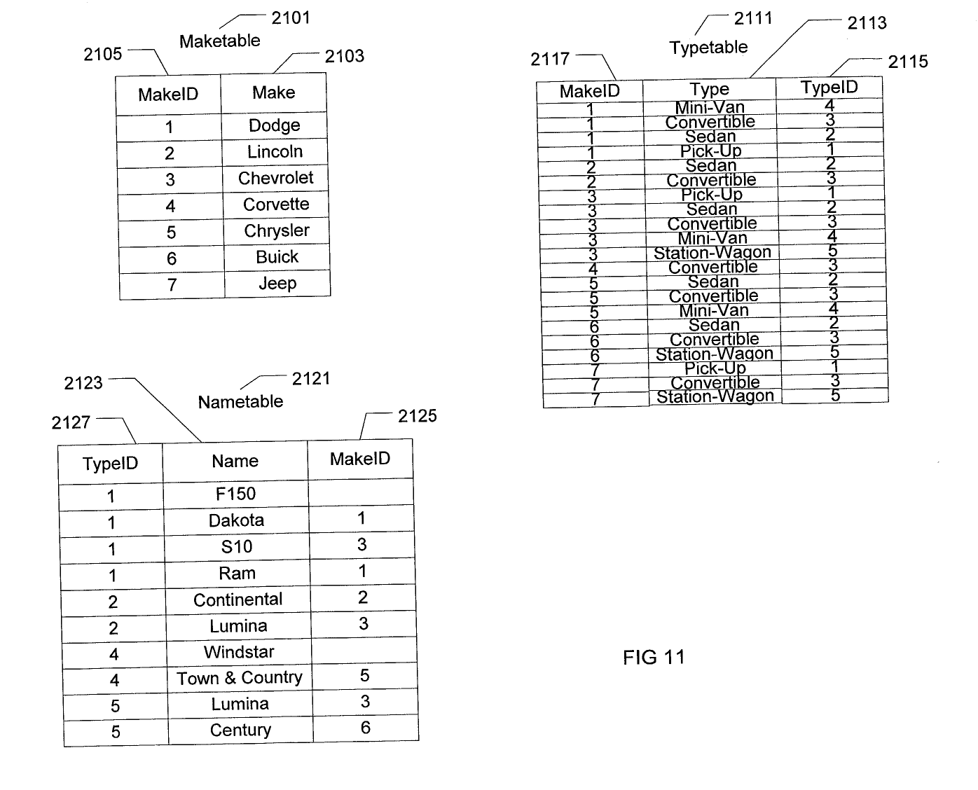

The problem with SQL searching of traditional databases with these desired properties should be clear but it becomes even more stark when the database becomes more complex. FIG. 11 shows a database of information, but the information is now stored in three interrelated tables where values of a table have one-to-many relationships with later tables. The interrelationship between multiple tables of data in FIG. 11 is more like what would actually be stored in a relational database although it is still significantly simplified.

In FIG. 11, there is a maketable (2101) which provides the makes of the cars in one column (2103) and key identifiers in a second column (2105). The key identifier is what is called a primary key as it uniquely identifies a value in a row. In this way it can be assured that different values can always be uniquely identified. The typetable (2111) provides the types of cars in one column (2113) and primary key identifiers in another column (2115). It further has a foreign key column (2117) that relates to the makes. The final table is the nametable (2121) which provides for many of the names that specific types of cars are sold under. This table contains a column of names (2123) and also contains a column of foreign keys (2127) that relate the types of vehicles to the makes of vehicles (2125). Let us now examine the search to provide the names of all cars in the database. The user would provide a Select command like the following:

| | |
|---|---|
| SELECT maketable.make, typetable.type, nametable.name | [3] |
| FROM maketable, typetable, nametable | |
| WHERE nametable.makeID = maketable.makeID and nametable.typeID = | |
| typetable.typeID and typetable.makeID = maketable.makeID. | |

The number of compares gets quite dramatic here. To quickly show the equation. There are 7 items in the maketable. For each of these there are log2 (21) compares performed on typetable, and for each of the 21 entities in typetable, there are Log2 (10) compares performed on nametable. This results in 7*(Log2 21)+21*(Log2 10) or about 100 compares.

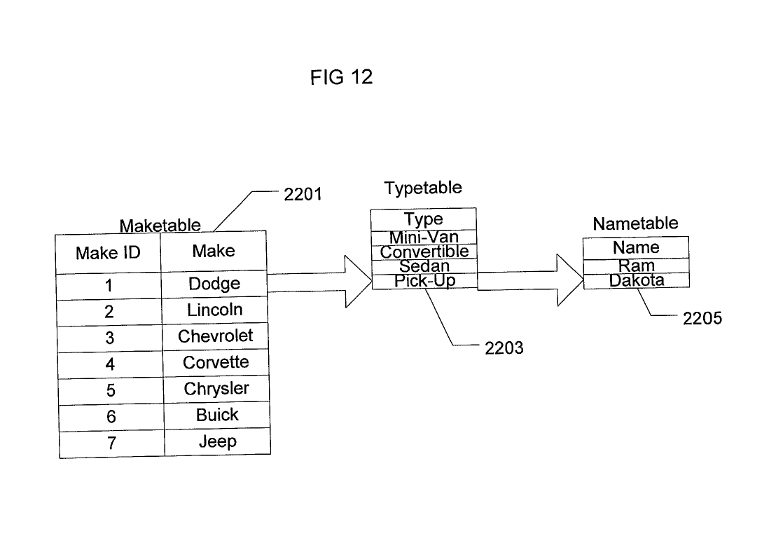

FIG. 12 shows how an ERDB could handle the command to return all the values from FIG. 11 in order to save resources. In the ERDB, it would be necessary to go through each row of the maketable just as in an SQL database as shown in the first column (2201), however, for each value, there exists a linked list of all the types (2203) so there is no need to compare, in addition each type can already have a linked list of each name (2205) so there is also no need to perform this compare. This means that there are zero total compares. The records are simply returned for all 21 of the records in typetable (only 10 records if name=NOTNULL since some types do not have any names provided).

In addition, by examining FIGS. 11 and 12, it is apparent that the entity-relationship database can avoid returning redundant data. Where the relational database will return a “make.type.name” for every entry matching the query (three pieces of information) the entity-relation database will return “make.type” once and “name” for every entry that matches the query. This means there is one piece of information for every entry +two “overhead” pieces. The transmission savings should be readily apparent but a more graphic numerical example may make the savings clearer. Assume a user wished to return every piece of data for 100 initial searches where each initial search provided 100 pieces of data and each of those pieces of data provided another 100 pieces of data. In the entity-relation case you would return 1,010,100 pieces of information (100 pieces of data from the first group 100*100 pieces of data from the second group and 100*100*100 pieces of data from the third group). In the relational case you would return 3,000,000 pieces of information, 3 pieces of data for each of 1,000,000 entries.

From this discussion it should be quite clear that there is enormous benefit from being able to perform SQL type searches, or other searches formatted for searching non-ERDB databases, on an ERDB. The question therefore turns on how to use the SQL (or other search) form on an ERDB.

In one embodiment, the ERDB is created with predetermined knowledge of the types of SQL queries that are to be asked and a conversion methodology for returning the correct result for any of those predetermined SQL queries. FIGS. 5 and 10, show how this is possible. The data in FIG. 5 has a predefined query built in. The query is that a user will want to know types of vehicles manufactured by a particular manufacturer. This query is built in because the linked list of the entity-relation database can generate a list of types when given the manufacturers, it cannot generate a list of manufacturers from a given type (that is provided by the database in FIG. 6). The database in FIG. 5 therefore has the built in query “tell me all the types of cars manufactured by X” where X is the manufacturer(s) specified by the user, or the parameter of the query. Examining this text, and the table in FIG. 10, it is also clear that this query can be represented in SQL language as

| | |
|---|---|
| SELECT maketable.make, typetable.type | [4] |
| FROM maketable, typetable | |
| WHERE maketable.makeID = typetable.makeID and maketable.make = X | |

The reader should notice that this is identical to query [2] except that in query [2] the parameter X has been replaced by the user defined variable “Chevrolet”. This form of the query can therefore be considered the procedure portion of a query. The procedure being, the type of search that is always performed to find certain types given a manufacturer. The “X” then indicates a parameter (the desired manufacturer) that needs to be filled in by a user to determine the search. It is also the case that the ERDB of FIG. 5 was generated with this query in mind, as no matter the parameter, the entity-relation database can provide the answer by searching in entity field #1 (103) for the parameter and then returning the linked list attached to that parameter.

It should also be apparent, that the “X” could be eliminated (or could be set to every value) to return the entire contents of FIG. 5 as query [1]. In addition, the parameter X could incorporate any of the subvalues that can be provided to SQL. These include, but are not limited to, values such as >, >=, <, <=, NOT, LIKE, IN, or BETWEEN. The alternative method for searching the data in FIG. 10 is the general question: “what car makers make cars of type Y” where Y represents the parameter. This can also be represented by the SQL query

| | |
|---|---|
| SELECT maketable.make, typetable.type | [5] |
| FROM maketable, typetable | |
| WHERE maketable.makeID = typetable.makeID and typetable.type = Y | |

This SQL procedure can be stored with relationship to searching FIG. 6 because it is the opposite direction of previous query [4] and the SQL query can correspond to the command to search entity field #4 (403) for the parameter and return the associated linked list.

Both of the above described SQL queries are of a particular form, in particular, the queries comprise two portions. The procedure and the parameter. The procedure is the format of the select command, and the parameter is the component that is the “X” or “Y”, the user defined variable. These two pieces therefore comprise the necessary building blocks to access the ERDB using the SQL language. In particular, each procedure can be associated to a specific command to the ERDB to perform a search in a certain entity field and return a certain linked list based on the parameter which will be identified when the query is entered. This is an inquiry path associated with the ERDB.

A query that could have been used in SQL could also be used in this search scheme. The reason being that the first search performed is the same type of search as the SQL search, (searching maketable is identical to searching entity field #1 because as was pointed out above, they contain the same information). The difference lies in the ERDB being able to provide all connections to the data in other tables automatically because it does not have to compare the found values to the values in those other tables. Put another way, searching the entity-relation database works the same way as searching a relational database, except that the tables are virtual and are already prelinked together. Thus, the searching is already performed on the subsequent table before the search is entered. The compares do not have to happen, the data is simply returned. Therefore, the time it takes to search any command is dependent only on the number of values in the initial list to be searched. This is as opposed to the relational database that has the same search, but then has the additional compares. In addition, the ERDB can return fewer pieces of information. Since there are no compares, the relationship is already known and does not have to be returned.

The virtual table is shown in a partial format in FIG. 12. Examining FIG. 12 the virtual table is formed by placing the found values from the linked lists together in a table along with the reference to the linking. It should be clear that if such an action was performed for every entry in maketable in FIG. 11, FIG. 12 would create the tables in FIG. 11. FIG. 12 contains “virtual tables” that are the tables of FIG. 11.

The fact that the ERDB can be represented with these virtual tables, can be used in another embodiment. Since the tables are virtual and are not actually stored, it is also possible to have a virtual table that for some values has no data and takes up no space. One example of tables containing no data is provided by the later car types shown in FIG. 11 (as they have no names associated with them). Another example of this would be in returning database values where the existence of data would be dependent on the result of other data. To use a simple example, suppose a database of survey results has many different fields and tables. In the survey, however, only certain respondents were asked to respond to certain questions. An example might be that female respondents were asked to answer question 52 and not question 53, while male respondents were asked to answer question 53 but not question 52. If one now wants to look for the results of question 52 compared to the results of a question other than sex, in the relational case, it would be necessary to search the results of all the respondents to question 52 (half of which are blank) for those that are desired. In the entity-relation case, however, question 52 has a virtual table (there is nothing in existence) containing no data for those respondents who are male, and a complete table with no blanks for those respondents who are female. The first virtual table takes no space because it has no values. In the linking list, the blanks are eliminated. This means there is no storage of responses for those who are male because there are no links. This can save storage space when data is conditional as blanks do not have to be stored.

In another embodiment, it becomes clear that for any world of data, all of the queries can be predefined and the entity-relation database can be arranged to cover all desired queries. In the above case, that database is described in FIG. 7. As discussed above, FIG. 7 shows a concatenated version of the combined entity relationship of FIGS. 5 and 6. It can perform searches in both directions the same as the tables in FIG. 10. That means that both the above defined queries [4] and [5] can be performed on FIG. 7 by passing the related entity-relation searches to FIG. 7. Such a combined entity-relation database can also be created for the data shown in FIGS. 11 and 12 although the database would be more complicated. This means that an ERDB can be generated in a fashion that allows for any search that could be desired on any type of data. By simply working through all the possible searches, every query is predefined and the database can be searched through any search. This means that any search could be accomplished with no compares regardless of the size or complexity of the database.

In a further embodiment, the searches can be further simplified. Referring back to FIG. 5, there is an additional possible search not yet discussed. That is

| | |
|---|---|
| SELECT maketable.make, typetable.type | [6] |
| FROM maketable, typetable | |
| WHERE typetable.type = ?1 and maketable.make = ?2 | |

An example of this type of search would be one where both the make and type begin with the letter “c” for example. This search could be placed as a procedure and parameter that is set to recall a particular search of the database in FIG. 7. However, this search could be simplified into a different entity-relationship search. In particular, it could be the search, find typetable.type =?1 and return the linked list, but only provide those values where maketable.make =?2. The query has here been broken into two smaller queries, the first of which is identical to query [4] above and the second of which is query [5] above, performed on the results found from query [4].

This means that the universe of queries can be shrunk into a smaller universe of queries by allowing certain queries to be interpreted as a collection of smaller queries. This further accelerates searching as it now means that each query can be an optimized query enabling even quicker retrieval. It also means it is easier to define the universe of queries in a complex database allowing the predetermination of all possible queries to be a simpler process.

In another embodiment, the predefined queries and the input of variables are defined as two separate portions of an embedded SQL (ESQL) language. In this arrangement, the entity-relation database can separate the processing of the SQL query into a separate “prepare” phase and an “execute” phase. The two phases correspond in a general fashion to the ideas of preparing a known query and then executing it with the provided parameter, but there is a slight variation. In particular, the prepare phase will generally be a runtime function (although it could be a preprocessor) that is called once to build an optimized version of the SQL statement. This will generally be a method for turning the SQL query into a selection of smaller pieces, each of which corresponds to one of the predetermined SQL queries. These queries can then be executed using the user provided parameters in the execute phase.

In another embodiment, the search can be accelerated again by maintaining the ERDB in such memory devices as will permit access in the shortest possible period of time. While generally it is preferred that the entirety of the database, including all of the relation defining fields, be maintained in the CPU memory of a selected computer, the use of virtual memory permits portions of the database to be stored in other devices which will only occasionally cause certain delays to occur. Regardless of the partition of the database to various memory devices, it is also desirable in one embodiment that a back-up scheme be provided so that in the event of system failure, the database can be quickly reconstructed.

Although certain embodiments of these systems and methods are disclosed herein, it should be understood that other embodiments are envisioned as would be understood by one of ordinary skill in the art. Although described by reference to specific embodiments thereof, it is not intended that the methods and systems be limited to those illustrative embodiments. Rather, it is intended that all variations and modifications as fall within the spirit of the embodiments be included within the scope of the following claims.

claims

1. A data processing system for retrieving data elements of an entity-relation database (ERDB) comprising:
a memory containing the ERDB;
means for establishing inquiry paths to the data elements of the ERDB, the inquiry paths corresponding to known associations between the data elements;
means for relating the inquiry paths to query procedures; and
means for storing in the memory a listing of the query procedures and the related inquiry paths.

2. The data processing system of claim 1, further comprising:
means for comparing an input query to the listing of the query procedures to obtain a query procedure matching the input query; and
means for executing the inquiry path related to the query procedure matching the input query to retrieve the data elements that the related inquiry path is established to.

3. The data processing system of claim 1, further comprising means for generating data tables by using linking pointer lists of the ERDB to associate data elements of at least one entity field of the ERDB to data elements of other entity fields of the ERDB.

4. The data processing system of claim 3, further comprising means for querying the generated data tables in accordance with an input query to retrieve the data elements when the input query does not match a query procedure.

5. The data processing system of claim 2, wherein:
the means for comparing further comprises means for matching the input query to the listing of the query procedures to obtain a plurality of query procedures each matching a portion of the input query; and
the means for executing further comprises means for iteratively executing the inquiry path related to each of the query procedures matching a portion of the input query to retrieve the data elements that the related inquiry paths are established to.

6. The data processing system of claim 5 wherein the means for executing further comprises means for incorporating at least one parameter from the input query in the inquiry path to retrieve at least one subset of the data elements that the related inquiry path is established to, the at least one subset defined by the at least one parameter.

7. The data processing system of claim 2, wherein the means for executing further comprises means for incorporating at least one parameter from the input query in the inquiry path to retrieve at least one subset of the data elements that the related inquiry path is established to, the at least one subset defined by the at least one parameter.

8. The data processing system of claim 2, further comprising:
means for inputting the input query to a network connection; and
means for receiving the input query from the network connection.

9. The data processing system of claim 8, wherein the network connection further comprises at least one of a Internet connection and a World Wide Web connection.

10. The data processing system of claim 8, wherein the means for inputting further comprises means for inputting a Structured Query Language (SQL) query as the input query.

11. A memory for storing data elements in an entity-relation database (ERDB) for access by an application program being executed on a data processing system, comprising:
inquiry paths to the data elements of the ERDB, the inquiry paths corresponding to known associations between the data elements; and
query procedures related to the inquiry paths, the query procedures and inquiry paths stored in the memory, an input query of the application program matching a query procedure causing the execution of the related inquiry path to retrieve data elements in accordance with the associations corresponding to the related inquiry path.

12. The memory of claim 11, further comprising data tables generated by linking pointer lists of the ERDB associating data elements of at least one entity field of the ERDB to data elements of other entity fields of the ERDB, the data tables queried by the input query when the input query does not match a query procedure.

13. The memory of claim 11, wherein the query procedures further comprise variable parameters, a parameter value from the input query to the variable parameter of the matching query procedure causing the execution of the related inquiry path to retrieve a subset of the data elements, the subset defined by the parameter value.

14. The memory of claim 11, further comprising:
a client portion identifying the input query; and
a connection portion establishing a session for communicating the input query between the client portion and a server portion accessing the query procedures.

15. The memory of claim 14, wherein the connection portion further comprises at least one of an Internet connection and a World Wide Web connection.

16. The memory of claim 15, wherein the input query further comprises a Structured Query Language (SQL) query.

17. A program storage device readable by a machine, tangibly embodying a program of instructions executable by the machine to perform method steps for retrieving data elements of an entity-relation database (ERDB), said method steps comprising:
establishing inquiry paths to the data elements of the ERDB to correspond to known associations between the data elements;
relating the inquiry paths to query procedures; and
storing in the program storage device a listing of the query procedures and the related inquiry paths.

18. The program storage device of claim 15, wherein the method steps further comprise:
comparing an input query to the listing of the query procedures to obtain a query procedure matching the input query; and
executing the inquiry path related to the query procedure matching the input query to retrieve the data elements that the related inquiry path is established to.

19. The program storage device of claim 17, wherein the method steps further comprise generating data tables by using linking pointer lists of the ERDB to associate data elements of at least one entity field of the ERDB to data elements of other entity fields of the ERDB.

20. The program storage device of claim 19, wherein the method steps further comprise querying the generated data tables in accordance with an input query to retrieve the data elements when the input query does not match a query procedure.

21. The program storage device of claim 18, wherein:
comparing further comprises matching the input query to the listing of the query procedures to obtain a plurality of query procedures each matching a portion of the input query; and
executing further comprises iteratively executing the inquiry path related to each of the query procedures matching a portion of the input query to retrieve the data elements that the related inquiry paths are established to.

22. The program storage device of claim 21, wherein executing further comprises incorporating a parameter from the input query in the inquiry path to retrieve a subset of the data elements that the related inquiry path is established to, the subset defined by the parameter.

23. The program storage device of claim 18, wherein executing further comprises incorporating a parameter from the input query in the inquiry path to retrieve a subset of the data elements that the related inquiry path is established to, the subset defined by the parameter.

24. The program storage device of claim 18, wherein the method steps further comprise:
inputting the input query to a network connection; and
receiving the input query from the network connection.

25. The program storage device of claim 24, wherein the network connection further comprises at least one of a Internet connection and a World Wide Web connection.

26. The program storage device of claim 24, wherein inputting the input query further comprises inputting a Structured Query Language (SQL) query.
